(19) United States
(12) Patent Application Publication
(10) Pub. No.: US 2025/0348571 A1
(43) Pub. Date: Nov. 13, 2025

(54) Device and Method for Providing Customizable Secure Access to a Computer System

(71) Applicants: Michael Bojkovic, Pinellas Park, FL (US); Gerald Grant Cleveland, Seminole, FL (US)

(72) Inventors: Michael Bojkovic, Pinellas Park, FL (US); Gerald Grant Cleveland, Seminole, FL (US)

(21) Appl. No.: 19/206,529

(22) Filed: May 13, 2025

Related U.S. Application Data
(60) Provisional application No. 63/646,587, filed on May 13, 2024.

(51) Int. Cl. G06F 21/43; H04L 9/32

(52) U.S. Cl. CPC G06F 21/43; H04L 9/3228; G06F 2221/2113; G06F 2221/2141

(57) ABSTRACT

A security system for a computer environment implements a highly customizable and secure method for providing data and other electronic access to a computer system that does not require users to login to an electronic (computerized) system using a username and password, thereby eliminating the need for the users to remember usernames and passwords. Furthermore, the security system enables the computer system to provide limited access to elements of the computer system based on a subset of the user's total or overall privileges in the computer system, based on tasks the user is requested to perform, based on time, or based on any of a number of criteria. Still further, the security system enables a user to be directed, in the first instance when accessing the computer system, to a particular page or component of the computer system instead of to a “home page” of the computer system.

### CROSS-REFERENCE TO RELATED APPLICATION

This application is a regular filed application of and claims the benefit of priority to U.S. Provisional Application No. 63/646,587, filed May 13, 2024, entitled “Device and Method for Providing Customizable Secure Access to a Computer System,” the entire disclosure of which is hereby expressly incorporated by reference herein.

### FIELD OF DISCLOSURE

This patent relates to a device and method that provides robust, customizable and highly secure access to computer systems and applications and data hosted on computer systems.

### BACKGROUND

Typical computer systems, such as business systems, medical systems, banking systems, purchasing systems, etc., provide various functionality to the users thereof, such as accessing one or more databases and performing tasks in a computer environment created for the business or other provider of the computer system. However, in most cases, these computer systems have or store personal or private information which can or should only be shared with or accessed by authorized users. As a result, many computer systems use a secured access methodology to enable authorized users to access an electronic or computer environment provided by or implemented by a computer system, so as to prevent unauthorized people from accessing the computer system and to limit authorized persons to be able to access data or other computer programs provided by the computer system according to a set of pre-defined privileges for that user.

In secured systems, it is common to use a so-called “two-factor authentication” to enable a user to gain access to a computer environment, including applications and databases within that environment. Generally speaking, two-actor authentication procedures require a user to login to the computer system using a username and password. Upon verifying the username and password with stored records of authenticated users, the computer system sends a code of some sort (e.g., a four or six digit number randomly generated by the computer system) to the user at a phone number or at an email address stored for the user in the computer system. The user must then access the code from the user's phone or email service, for example, and must enter the code (typically in a predefined period of time) via the login interface of the computer system. Upon entering the correct code, the computer system enables the user to access the data and applications within the computer system that are defined by the user's privileges in the system.

Unfortunately, these two-factor security systems generally require that users remember their username and password for the computer system, which can be difficult as, in many cases, users have access to many different computer systems and each of those systems typically requires a username and password, which may be different from system to system. In many cases, a username for a computer system is based on a user's email or is chosen by the user when first logging into the computer system. Likewise, the password is typically another alpha-numeric text string chosen by the user. Different computer systems may have different rules or criteria associated with a valid password, such that passwords for different computer systems may have different minimal lengths or characters, may or may not have to include special characters, may or may not have to include one or more capitalized letters, may or may not allow repeat characters in the password string, etc. Still further, best practices dictate that a user should use a different password for each different computer system to which the user has access, to limit the ability of an unauthorized user from gaining access to another person's accounts if one of that person's passwords becomes compromised.

Practically, however, users tend to forget their username and password, and must then ask the computer system to which the user is logging into to send them their username and/or to reset their password. This is especially the case for users who do not use a particular computer system frequently, and who may only access the particular computer system once a week, once a month, etc., making it more difficult for the user to remember the username and password they have set up for the particular computer system.

As a result, these two-factor authentication systems, while being extremely secure, can be frustrating for a user as it puts the onus on the user to remember their username and password for each of the computer systems to which they have access. This means that many users write down or otherwise store a list of usernames and passwords for the various different computer systems that they use, which greatly compromises the security of a username and password type security system. To help reduce this problem, third party password management programs exist which electronically track and record usernames and passwords (in encrypted form) for each of the different computer systems that a user may log into and that assists the user in filling out the correct username and password for each different computer system to which the user has access. However, these password management programs or applications still require the user to provide, in some manner, a username and password for each security protected computer system and typically the user must pay for using these third party systems.

### SUMMARY

A security system for a computer environment described herein implements a highly customizable and secure method for providing data and other electronic access to a computer system by a user, while enabling individuals to conveniently login to an electronic (computerized) system without needing to remember usernames and passwords. In some cases, the new security system enables the computer system to provide limited access to elements of the computer system based on a subset of the user's total or overall privileges in the computer system, based on tasks the user is requested to perform, based on time, or based on any other of a number of criteria. Still further, the security system described herein enables a user to be directed, in the first instance when accessing the computer system, to a particular page or component of the computer system instead of to a “home page” of the computer system.

Generally, to implement secured access to a computer system, the security system associated therewith sends a user an electronic link to access the computer system via, for example, email, SMS messaging, etc. The link includes a unique identifier code generated by the security system which will be used by the security system to uniquely identify the user and possibly to identify other information associated with providing access to the user. For example, the unique identification code may also identify one or more components of the computer system to which the user may be provided access based on the use of the link, identify a landing spot within the computer system to which the user will be first directed when given access to the computer system, identify a time associated with the access to the computer system by the user, such as a window of time during which the user may access the computer system and/or an amount of time that the user may be logged into the computer system when the user accesses the computer system, identify computer system resources (such a response times, download or upload speeds, bandwidth, computer processing resources, database storage, etc.) to be dedicated to the user based on use of the link, or identify any other access privileges to be provided to the user based on the use of the link. Still further, the link may be sent to the user in a message that is assessable only via a password protected application or device, such as an email message in a password protected email application, an SMS message sent to a password protected cell phone, etc.

When the user selects the link, the unique code within the link is provided back to the security system of the computer system and the security system uses this link to establish the rights associated with the unique identifier of the link, such as the person or user associated with the link, the location or access parameters of the computer system to which the user is to be directed, etc. In one case, the security system runs a script associated with the code and the script then performs one or more tasks associated with access rights of the user, such as identifying the user associated with the link or the unique identification code within the link, identifying the access privileges associated with the unique identification code in the link, etc. To perform the two-factor identification, the security system (or the script) then generates and sends an authentication code to the user associated with the unique identification code within the link via a messaging methodology stored for the identified user. The authentication code may be any type of code, such as a four digit or six digit code, a word or other text string, a combined word or text string, etc., and this code may be sent to an email address associated with and previously stored for the identified user, to a phone number (as an SMS message for example) associated with and previously stored for the identified user, etc. The user then enters the authentication code via the computer system interface and, if the entered code is correct, i.e., matches the authentication code just sent by the security system, and if the code is entered within a certain amount of time, e.g., 5 minutes, then the security system (or the script) enables access by the user via the user interface of the computer system. The security system or script may enforce or establish access rights or privileges associated with the unique identification code within the link, including what access rights the user has (which may be more limited than the full access rights of the user), what page or component of the computer system (landing spot) that is to be presented to the user immediately upon giving the user access to the computer system, the amount of time the user can use the computer system, a window of time during which the user can use the computer system, etc. The security system may, if desired, log the user in via a stored username and password within the computer system for the user and may drop the user at a home page of the computer system, or the security system may enable access without actually going through a login username and password login procedure as is typically performed, as the security system can identify the user from the unique identification code within the link sent to the user.

This methodology thus verifies the identification of a user based on a link sent to the user at a previous time instead of a username and password entered by the user when logging in to the computer system. When the user activates the link, the security system sends a verification code (generated by the security system of the computer system) to an electronic address stored for the user (e.g., an email address or a phone number), which enables the user to perform the second part of the two-factor authentication. When the user enters the correct verification code, the user is provided immediate access to the computer system. Using this system eliminates or reduces the need for a user to remember a username and password for the computer system, as long as the user has access to the link sent to the user by the computer system. This authentication methodology thus makes it easier and quicker for a user to login to a computer system as it does not require the user to remember a username and password. Moreover, this authentication methodology enables the computer system to limit the rights or access privileges of the user based on the unique identification code instead of granting the user full access rights to the computer system based on a general login using a username and password. In particular, different unique codes can be sent to the same user to enable the user to access different parts of the computer system, or to have different access privileges based on the code used. Such access privileges may include, for example, viewing information in a database of the computer system, changing information in the computer system database, running different programs associated with the computer system, etc.

### DRAWINGS

FIG. 1 depicts an example computing system that implements a new two-factor authentication process described herein.

FIG. 2 is a flow chart that may be used by the system of FIG. 1 to implement the two-factor authentication process described herein.

FIG. 3 is a depiction of a screen display that may be provided to a user to enable the user to select one of a number of different login links to gain different types of access to the computer system.

### DETAILED DESCRIPTION

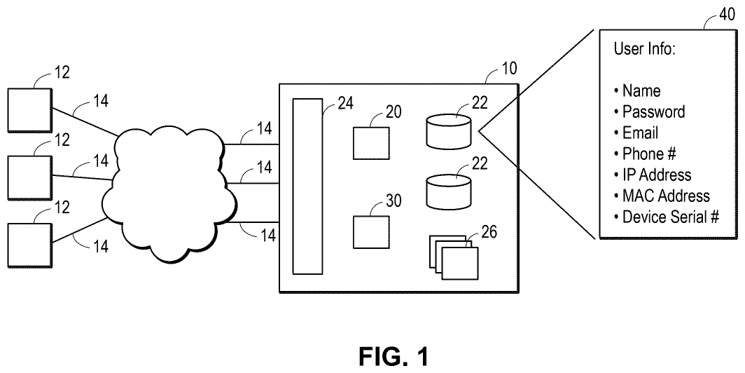

FIG. 1 illustrates a computing system 10 connected to multiple client devices 12 via one or more electronic communication networks 14. The computing system 10 includes one or more processors 20, one or more databases 22 and one or more communication interfaces 24 that may be used to communicatively connect to the client devices 12 via the communication networks 14. Moreover, the computer system 10 may include one or more applications 26 that execute on the one or more processers 20 to perform any desired functionality, including accessing data from and/or writing data to the databases 22, interfacing with users at the client devices 12, performing calculations and data manipulation, performing analysis, or any other computer related activities. Generally, the computer system 10 may be any desired type of system that performs any desired functions and that requires users of the computer system 10 to be authorized and authenticated to use the system 10 or the components thereof. Thus, the databases 22 of the computer system 10 may store any type of data in any desired format and the applications 26 of the computer system 10 may perform any desired functionality associated with any personal, business or other organizational use. As an example, the computer system 10 may be a banking system that enables users to access banking information and perform banking activities, a business system that enables users to access business data and perform business actions or functions of any sort, a medical record or medical support system that stores medical data and enables users to perform medical related functions, a shopping system that enables a user to browse and purchase items, a design system that enables user to access and create designs of any kind, etc. There is of course an unlimited number of types of computer systems that may use the two-factor authentication procedure described herein and, generally, any computer system that typically supports known end users by storing and using user data in the form of a username and a password to enable a user to gain access to the computer system may use the two-factor authentication process described herein.

As illustrated in FIG. 1, the computer system 10 further includes a security manager 30 which may operate to manage user authentication and user access to the computer system 10 and the components thereof, such as to any of the data in the databases 22 and any of the applications 26. Generally, the security manager 30 operates to authenticate users who attempt to access the computer system 10 via any of the client devices 12, which may be computer devices of any type, such as phones, laptops, desktops, tablets, etc. While the system of FIG. 1 illustrates that the client devices 12 (each of which has an associated processor, memory and communication interface) are connected to the computer system 20 via external or public communication networks 14, which may be wired or wireless or combined wired and wireless networks, such as the internet, telephone networks, or other cloud-based communication connections, the client devices 12 may connect the computer system 10 via private networks, via dedicated networks, via direct connections, or via any other type of communication connections.

Traditionally, as noted above, a security manager of a computer system provided known end-users (such as employees or contractors or other known authorized users) of computer system software three elements to access an online (internet based) electronic data system. These elements included a web address; (e.g., a URL), an account name (or username) and a password, and these three elements were used to initiate a connection between the client computer device and an electronic computer system (also referred to herein as a host server or host device). As noted above, the user typically had to establish and maintain a complex password to achieve proper security. Passwords typically require complexities (numerous characters, special characters, no recognizable words, etc.) and are hard to remember, and passwords often expire, requiring the end-user to generate a new password. As also noted above, it is unsafe to ‘jot down’ the account names or usernames or the complex passwords associated with the account names, either on paper or within a computer notepad, as notating passwords increases the risk of the information being accessed (or worse, downloaded) by unauthorized individuals. Moreover, with known security measures, the user had to access the computer system via the provided web address, and was then prompted to enter the username and password via a login screen. The security manager then checked the username and password combination within its database to make sure the combination was valid and to establish the access privileges of the user. When implementing two-factor authentication, the security manager then generated a code, typically a random or pseudorandom authentication code, which the security manager sent to the user via a previously established address, such as via a text message to a phone number, via an email to an email address, via a voice call to a phone number, etc. The security manager then waited for the user to enter the authentication code via the login interface (such as a pop-up window sent to the user at the client device) and if the entered code was correct, authenticated the user and allowed the user access to the computer system based on the access rights or user privileges previously stored for that user. The system then placed the user at a home page of the computer system. From there, the user had to navigate to the location (or page) that included the functionality that the user wanted to use or access. As noted above, this login process could be tedious (as it required multiple steps) and could be frustrating to the user as it required the user to remember the username and password for the computer system.

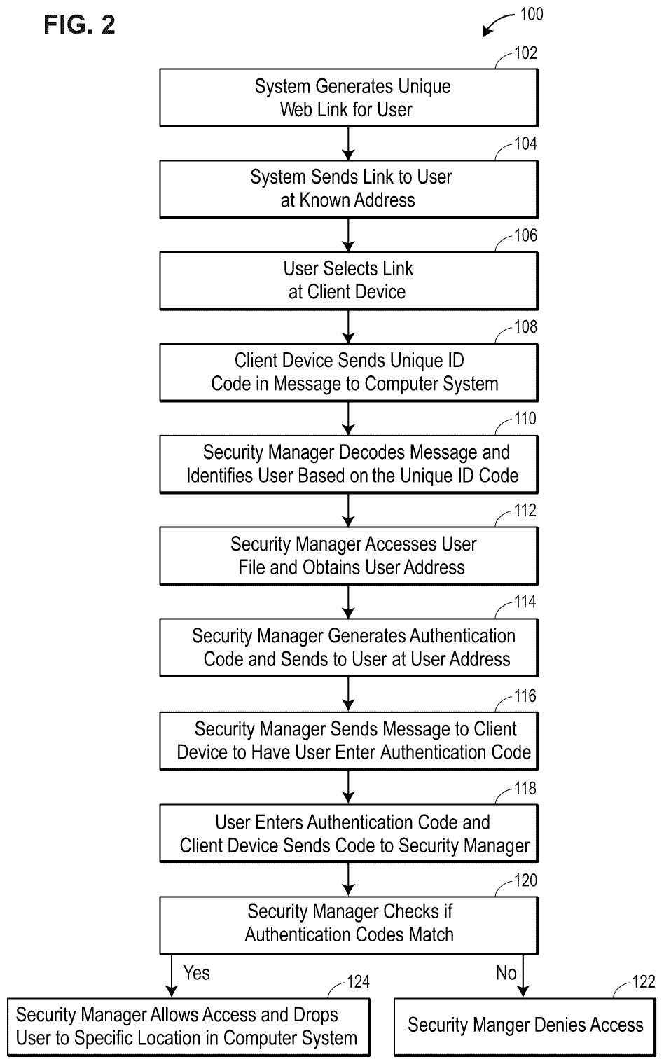

The new access procedure used by the security manager 30 of FIG. 1 will be described in conjunction with the flow chart 100 of FIG. 2, some aspects of which are completed by the computer system 10 and some aspects of which are completed by one or more of the client devices 12. In particular, the security manager 30 of the access system described herein, at a block 102, instead of providing users with an account name and password to access the computer system 10, first generates a web browser link (URL) which is unique to each user to enable a user to gain access to the computer system 10. In particular, the web browser link generated by the security manager 30 includes data that identifies the destination (host device) and also includes a UUID (a Universally Unique Identifier), which is a unique identification code associated with the user, which in this case replaces both the account name and password. The security manager 30 stores the unique identification code as being associated with a known and previously verified user within the computer system 10, such as within one of the databases 22. An example link that the security manager 30 may generate to initiate the connection with the computer system 10 is provided below. Importantly, this link is custom created per individual user with the italicized portion being the unique identification code tied to a particular user:
https://[system.wherever.com]/[database]?script=UponOpening&parameter=B2Lz-4223-LAgu-M6V1-APPb-1117

At a block 104, the security manager 30 sends or otherwise provides the unique link to the known user at one of the client devices 12 (by, for example, emailing the unique link to the user at an email address stored in the computer system 10, which email address has previously been established for the known and verified user). When, at a block 106, the user clicks on or selects the link, the client device 12 being used by the user, at a block 108, sends the computer system 10 a message over the communication link 14 (e.g., the internet) requesting access to a computer system 10 database (information system). The message sent by the client device 12 will include the unique identification code. At a block 110, the security manager 30 decodes the message to retrieve the unique identification code and uses this code to identify the user that sent the request via use of the link by looking up the user to which the unique identification code has been assigned in the database 22 that stores that information.

If the unique identification code is valid (is currently associated with a particular authorized user), the security manager, at the block 110, then determines a match for the user requesting access. At a block 112, the security manager then accesses a personnel file for the matched user, illustrated as the file 40 in FIG. 1, that is associated with the unique identification code in the link and accesses a communication address for the user, such as a phone number or an email address as stored in the personnel file 40 for that user. The personnel file 40 may store various different types of data that is associated with or that identifies in some manner a known user. For example, the file 40 may store a user's name or other ID, a user's email address, a user's phone number, information about one or more computer devices (or client devices 12) from which the user is authorized to access the computer system 12, such as a MAC address, a device serial number, etc. or any other personal information for the user or devices used by the user. The personnel file 40 may also store a username and password for the user which may be used in a traditional manner to enable the user to gain access to the computer system 10.

At a block 114, the security manager 30 generates an authentication code (e.g., a 6-digit ‘Two-Factor Authentication Code”) and sends this authentication code to a messaging address of the user as stored within the personnel file 40 for the user. The security manager 30 may, for example, send the authentication code via an SMS message to a cell number on file for the requestor, via an email to an email address on file for the requestor, via a voice message for a phone number on file for the requestor, etc. At a block 116, the security manager 30 also sends a message (e.g., a page or a pop-up window) to the client device 12 from which the unique code was sent, asking the user to enter the verification code sent via the phone or email.

When the user receives the authentication code, the user then enters the authentication code via the login screen or a pop-up window at a block 118, and the client device 12 sends this code to the security manager 30. At a block 120, the security manager 30 checks the authentication code entered by the user in the login screen or pop-up window against the authentication code sent to the user via the phone or email message and if the authentication code was received in a certain amount of time (i.e., that the time period for receiving the code has not timed out), e.g., 5, minutes, 15 minutes, etc. If the two authentication codes do not match, the security manager 30, at a block 122, denies access to the computer system 10. However, if the two authentication codes match and the authentication code was received in the predetermined amount of time, at a block 124, the security manager 30 allows the user access to the computer system 10. In one case, the security manager 30 enables access by using the username and password stored in the personnel file 40 to log the user into the computer system in the traditional manner. In any event, when the security manager 30 verifies the authentication code match, the security manager 30 enables user access to the computer system 10 and presents the user with on-screen information and data (provided by one of the applications 26 for example) as expected in the past, such as when using the previous method of logging in with a username and a password, by dropping the user at a specified virtual location of the computer system, such as a home page. However, the computer system 10 could also drop the user at a virtual location specifically tied to the unique identification code.

As will be understood, this methodology implements two-factor authentication as it (1) establishes a user identity via the unique identification code previously provided to the user and then sent from the user back to the computer system 10 when the user wishes to gain access to the computer system 10 and (2) sends an authentication code via a different communication method (e.g., phone or email) to the user which assures that the user who clicked the link has access to the phone or email address to which the authentication code is sent.

To enhance security, the security manager 30 may randomly or pseudo-randomly generate and then send a new or different unique identification code for a particular authorized user every time that user attempts to access the computer system 10 or at other times or based on other factors. Moreover, the unique identification code may expire after a predetermined period of time after being sent to the user as part of the link, such in 5 minutes, one hour, one day, etc. In another example, the unique identification code in the link may only be valid for a specific window of time after being sent. In still another example, the unique identification code may only enable the user to have access (be logged into) the computer system 10 for a specific period of time (e.g., one hour) after the user uses the link to gain access to the computer system. Of course, any combination of these limitations or any other limitations can be enforced based on the particular unique identification code. In any event, different unique identification codes can be provided with different access rights or limitations so that one user may have different such access rights than a second user, as the access rights that a user is given can be associated with and enforced based on the unique identification code sent to and returned by the user. Likewise, the same user can be provided different access rights at different times using different unique identification codes. These features are especially useful for providing access to a computer system that generates information or tasks for the user and that then sends a link to the user to notify the user that the user needs to access the computer system 10 to obtain data or to perform some function within the computer system environment.

Still further, to enhance the security of the system, the unique identification code may be tied to or associated with a particular client device (or client devices) to be used by a particular user or set of users associated with the unique identification code. In this case, the link will only work to enable a user to login to the computer system 10 if the user does so via a known client device (i.e., a device having device information stored for the user in the user's personnel file 40). This feature provides additional security because it requires a login to be performed from a computer or client device 12 previously established to be one that is to be used by the authorized user. In this case, if the link is somehow intercepted and used from an unknown device (one not having a device identification stored in the personnel file 40 of the authorized user) then the security manager 30 will reject the login attempt. Of course, the MAC address, device serial number, or other device identification information for one or more client devices 12 may be stored in the personnel file 40 for a particular user (which may be associated with a single person or a group of people). When a user clicks on the link with the unique identification code, the security manager 30 may obtain the device identification information from the client device 12 from which the user clicks the link and is to access the computer system 10 via a separate request, and if this device information does not match device information for any of the devices stored in the personnel file 40 for the authorized user, then the security manager 30 may reject the login attempt.

Still further, the security of the login process can be enhanced by making the unique identification code longer and enabling more and different types of characters to be used in the unique identification code. For example, the overall security of the login process can be greatly enhanced by making the unique identification code 12 characters or longer and/or by enabling the unique identification code to include both upper and lower case characters, numbers, special characters (e.g., ASCII codes, emojis, etc.). In fact, this system can be more secure from intentional brute force hacking methods than most password protected login security systems used today as the unique identification code can be made to be much longer (more characters) than the minimum password length enforced by most password systems today and can be done so without any additional effort or inconvenience on the part of the user. In fact, making the unique identification code longer than 15, 20, 24, 30, 40, etc. characters makes it almost statistically impossible to hack but does not require additional effort or action from the user. Still further, it is possible to enhance the security of the system 10 by having the link sent to a user by the system 10 expire after a particular amount of time from being sent to the user, such as in one hour, one day, one week, etc. In this case, after the particular amount of time has expired (either with or without the user using the link), the security manager 30 will no longer recognize the unique identification code in the link as being associated with a user and the system 10 must generate and send a new link with a new unique identification code to the user. In another case, the unique identification code in the link may expire after a particular amount of time from when the user last used the link, so that the link stays valid as long as the user uses it regularly. It is also possible to further enhance the security of the system 10 by encoding the email which contains a link with a unique identification code sent to a user with a protection mechanism by which the user must enter some information known to the user to open the email (a so called “closed email”). For example, to open the email with the link, the user may have to enter a user identifier of some sort (known to the user), such as a user registration number, an employee number, a user address, a user birthdate, a user social security number, a user name or other information that is known to the user and typically remembered by the user. This additional user information may also be stored in the user personnel file 40 and the security manager 30 may protect the email sent to a user with a login link to force the user to enter this additional information prior to gaining access to the contents of the email.

Moreover, advantageously, the unique identification code generated by the security manager 30 may provide additional customized functionality to the login system for each user or for different users. For example, additional parameters (instructions) can be integrated into the customized URL given to each end-user. Additional parameters could be placed in the unique identification code which control various different access functionality or access rights of the user based on the use of the particular link. For example, additional parameters could be placed into the unique identification code of the link to specify where the user should be directed (e.g., the virtual landing page of the user) when the user is allowed access, and to limit or define the particular access rights that the user will have when using the link. As another example, parameters could be added to the unique identification code to specify one or more components of the computer system 10 to which the user may be provided access based on the use of the link (e.g., which data in the databases 22 and which applications 26 may be accessed or used by the user), to identify a time associated with the access to the computer system 10 by the user, such as a window of time during which the user may access the computer system and/or an amount of time that the user may be logged into the computer system when the user accesses the computer system, to identify computer system resources (such a response times, download or upload speeds, bandwidth, computer processing resources, database storage, etc.) to be dedicated to the user based on use of the link, or to identify any other access privileges or rights to be provided to the user based on the use of the link, such as whether the user can read or write data in the computer system 10.

In one example, the security system 30 may generate a unique identification code as below with a new parameter of Billings shown in italics:
https://[system.wherever.com]/[database]?script=UponOpeningBillings&parameter-B2Lz-4223-LAgu-M6V1-APPb-1117

Here, the additional parameters of “Billings” tells the security manager 30 to provide the two-factor authentication code above, but instead of navigating to the traditional Main Menu, the system 10 should auto-navigate the user to the Billings screen in the system 10 when the user is granted access.

Additionally, one or more parameters may be included in or tied to a unique identification codes that instructs the host system 10 to only allow the user access for two hours (for example), and then to deny all subsequent requests with this link for a seven day period. This dynamic access control of sensitive data adds an additional level of security to the system 10.

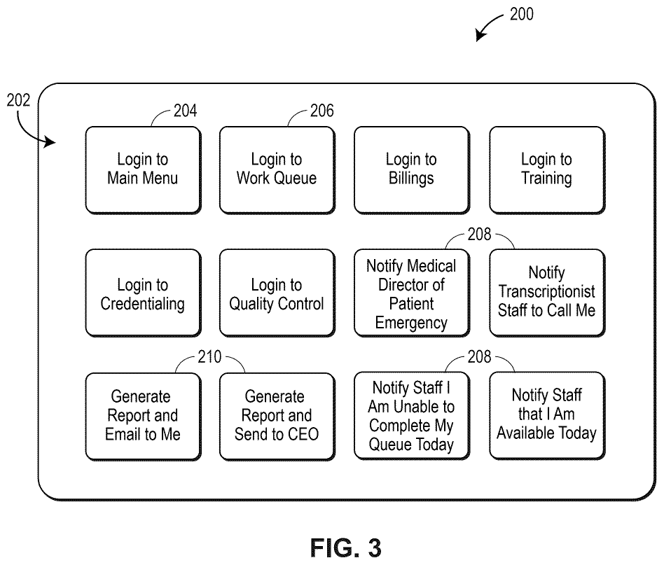

As still another example, the system 10 or security manager 30 may assign a particular end user a variety of different URLs (links) for different specific purposes, which can result in an on-computer inventory of tiles (buttons) on a client device 12, with each tile pre-programmed for the specific user and for a specific functionality, and emailed as a single file to the user to save on their desktop. FIG. 3 illustrates a screen 200 with such a set of tiles 202 that may be displayed on a client device 12, wherein each tile 202 has associated therewith a URL with a different unique identification code that enables the user access to the computer system 10 of FIG. 1, but that provides other and different functionality when the user gains access. Thus for example, a first tile 204 may direct the user to the computer system home page or main menu, while a second tile 206 may direct the user to a “Work Queue”. Other tiles 202 may direct the user to other sites or virtual locations within the computer system 10. Still other tiles 202, such as tiles 208 may take steps or perform functions when the user is authenticated via the associated link, such as notifying or contacting someone in the organization. Still other tiles 202, such as the tiles 210, may generate reports and take other actions. Of course, a separate tile may be created for any particular set of one or more steps or functions to be performed within the computer environment of the computer system using the tile (or link associated with the tile). Likewise, as noted above, different tiles could have different rights or privileges associated therewith, such as timing, access and computer resource privileges.

In any event, the security manager 30 or computer system 10 could email a web file to the end user with the tiles (and associated links) and enable the user to download the web page to their desktop or folder of their choice within their local computer. Then, at a later date, the user can open the page in a web browser and be presented with the on-screen information or tiles such as illustrated in FIG. 3. As described earlier, each tile has a customized URL embedded behind it. The URL has specific automated tasks whereby the end-user can simply click the desired tile to execute a URL and receive and enter a two-factor authentication code to authenticate, and then the system completes the selected task, such as navigating to a specific screen, transmitting phone calls/text messages/emails on behalf of the user to pre-defined recipients, running reports and distributing the reports to others or even themselves, etc. Of course, tiles or links could be associated with any other function or set of functions.

In one embodiment, the security system or security manager 30 may use one or more scripts to parse the unique identification code of a received link (or message based on the selection or clicking of a link at a client device 12). The script(s) may first identify the user associated with the link and perform any or all of the authentication tasks described herein to verify the user, including sending an authentication code, receiving a user response and matching the sent code with the response to enable user access. The script(s) may also use or parse the unique identification code to define and perform one or more tasks associated with access rights of the user, such as identifying the access privileges associated with the unique identification code in the link, enforce or establish access rights or privileges associated with the unique identification code within the link, including what access rights the user has (which may be more limited than the full access rights of the user), what page or component of the computer system (landing spot) that is to be presented to the user immediately upon giving the user access to the computer system, the amount of time the user can use the computer system, a window of time during which the user can use the computer system, etc. Of course, the unique identification code in the link may include parameters or fields that define or tell the script what action to take. However, such other actions or rights may be stored in the computer system 10, such as on one of the databases 22 and/or in one of the personnel files 40, as being associated with a unique identification code and the script(s) may read the data in the file 40 to determine what actions to take or access rights to provide to the user when the user passes the two-factor authentication process. In this second case, the additional actions or rights of the user based on the link are not actually placed in the unique identification code itself, but are stored within the computer system 10 as being associated with a unique identification code and are accessed when the unique identification code is used by a user to gain access to the computer system 10.

When implemented in software, the computer access system and the components or routines thereof described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention. Still further, the particular features, structures, and/or characteristics of any specific embodiment described and/or illustrated herein may be combined in any suitable manner and/or in any suitable combination with one and/or more other embodiments, including the use of selected features with or without corresponding use of other features. In addition, many modifications may be made to adapt a particular application, situation and/or material to the essential scope or spirit of the present invention. It is to be understood that other variations and/or modifications of the embodiments of the present invention described and/or illustrated herein are possible in light of the teachings herein and should be considered part of the spirit or scope of the present invention. Moreover, it will be understood that certain aspects of the invention are described herein as exemplary aspects but the invention described herein are not limited to these aspects and may not necessarily include each of these aspects.

1. A method for providing secure access to a computer system, comprising:
storing in a secured computer memory of the computer system, user information defining one or more authorized users of the computer system, each authorized user having a level of secured access to the computer system, the user information for each authorized user including an indication of a communication method for communicating with the authorized user; and
providing one of the authorized users access to a secured portion of the computer system implemented on one or more computer processors including;
generating via a computer processor associated with the computer system, a unique identifier associated with the one of the authorized users;
sending the unique identifier, via an electronic communication network from the computer system to a remote computer device associated with the one of the authorized users, as part of an electronic link pointing to the computer system;
generating, on the remote computer device in response to a user selecting the electronic link, a response message to the computer system, the response message including the unique identifier;
electronically sending the response message from the remote computer device to the computer system via a communication network using information within the electronic link pointing to the computer system;
using the unique identifier within the response message at the computer system to identify the one of the authorized users;
sending an authentication code from the computer system to the identified user via the communication method stored in the secured computer memory for the identified one of the authorized users;
enabling the user to enter the authentication code via the remote computer device;
verifying at the computer system that the authentication code entered by the user at the remote computer device matches the authentication code sent to the user; and
providing the user access to a secured portion of the computer system via the remote computer device if the authentication code entered by the user at the remote computer device matches the authentication code sent to the user.

2. The method of claim 1, wherein the unique identifier additionally identifies a landing page in the computer system for landing the user when the user is provided access to the secured portion of the computer system.

3. The method of claim 1, wherein the indication of a communication method for an authorized user includes an indication of a type of communication to use to send an authentication code to the user and an address or phone number associated with the user when using the indicated type of communication.

4. The method of claim 3, wherein the type of communication includes one of email communication, SMS text communication or telephonic communication.

5. The method of claim 1, wherein sending the unique identifier, via an electronic communication network from the computer system to a remote computer device associated with the one of the authorized users, as part of an electronic link pointing to the computer system includes sending the electronic link to the remote computer device in a manner that the link is only accessible using a password protected communication application.

6. The method of claim 5, wherein the password protected communication application is an email application.

7. The method of claim 1, wherein generating the unique identifier associated with the one of the authorized users includes generating a unique identifier code that uniquely identifies the user and identifies other information associated with providing access to the user.

8. The method of claim 7, wherein the other information associated with providing access to the user includes one of (1) an identification of one or more components of the computer system to which the user may be provided access based on the use of the link, (2), a landing spot within the computer system to which the user will be first directed when given access to the computer system, (3) a time frame associated with the access to the computer system by the user when using the link, or (4) an identification of computer system resources to be dedicated to the user based on use of the link.

9. The method of claim 1, wherein using the unique identifier within the response message at the computer system to identify the one of the authorized users includes executing, on a processor of the computer system, a script associated with the unique identifier, wherein the script performs one or more tasks associated with access rights of the user.

10. The method of claim 1, wherein the authentication code is one a six digit or greater code, a word or a text string, or a combined word or text string.

11. The method of claim 1, wherein verifying at the computer system that the authentication code entered by the user at the remote computer device matches the authentication code sent to the user includes determining if the authentication code was entered by the user within a particular period of time from when the authentication code was sent to the user, and denying access to the user if the authentication code was not entered by the user within a particular period of time from when the authentication code was sent to the user.

12. The method of claim 1, wherein providing the user access to a secured portion of the computer system via the remote computer device if the authentication code entered by the user at the remote computer device matches the authentication code sent to the user includes providing the user with limited access rights to the computer system as compared to full access rights granted to the user when the user logs into the computer system using a username and password.

13. The method of claim 1, wherein providing the user access to a secured portion of the computer system via the remote computer device if the authentication code entered by the user at the remote computer device matches the authentication code sent to the user includes automatically logging the user into the computer system using a stored username and password within the computer memory for the user.

14. A computer security system, comprising:
a secured computer memory that stores user information defining one or more authorized users of a computer system, each authorized user having a level of secured access to the computer system, the user information for each authorized user including an indication of a communication method for communicating with the authorized user; and
a secured access application stored on a computer memory and executable on a processor to:
generate via a computer processor associated with the computer system, a unique identifier associated with one of the authorized users;
send the unique identifier as part of a link in an electronic message, via an electronic communication network from the computer system to a remote computer device associated with the one of the authorized users, wherein selection of the link at the remote computer device causes the remote computer device to send a return message back to the computer system, the return message including the unique identifier;
obtain the unique identifier from the return message upon receiving the return message;
use the unique identifier obtained from the response message at the computer system to identify the one of the authorized users;
send an authentication code from the computer system to the identified user via the communication method stored in the secured computer memory for the identified one of the authorized users;
receive an authentication code entered by the user via the remote computer device and sent to the computer system via the electronic communication network;
verify at the computer system that the authentication code entered by the user at the remote computer device matches the authentication code sent to the user; and
provide the user access to a secured portion of the computer system via the remote computer device if the authentication code entered by the user at the remote computer device matches the authentication code sent to the user.

15. The computer security system of claim 14, wherein the unique identifier additionally identifies a landing page in the computer system for landing the user when the user is provided access to the secured portion of the computer system.

16. The computer security system of claim 14, wherein the indication of a communication method for an authorized user includes an indication of a type of communication to use to send an authentication code to the user and an address or phone number associated with the user when using the indicated type of communication.

17. The computer security system of claim 14, wherein secured access application sends the unique identifier as part of a link in an electronic message, via an electronic communication network from the computer system to a remote computer device associated with the one of the authorized users, in a manner that the link is only accessible using a password protected communication application or device.

18. The computer security system of claim 14, wherein the security access application generates the unique identifier associated with the one of the authorized users by generating a unique identifier code that uniquely identifies the user and identifies other information associated with providing access to the user when using the unique identifier code to provide access to the computer system.

19. The computer security system of claim 18, wherein the other information associated with providing access to the user includes at least one of (1) an identification of one or more components of the computer system to which the user may be provided access based on the use of the link, (2), a landing spot within the computer system to which the user will be first directed when given access to the computer system, (3) a time frame associated with the access to the computer system by the user when using the link, or (4) an identification of computer system resources to be dedicated to the user based on use of the link.

20. The computer security system of claim 14, wherein, when the security access application determines that the authentication code entered by the user at the remote computer device matches the authentication code sent to the user, the security access application provides the user with less access rights to the computer system as compared to full access rights granted to the user when the user logs into the computer system using a username and password.
